(19) United States
(12) Patent Application Publication
(10) Pub. No.: US 2009/0029148 A1
(43) Pub. Date: Jan. 29, 2009

(54) Metal Nanoparticle, Metal Nanoparticle Colloid, Method for Storing Metal Nanoparticle Colloid, and Metal Coating Film

(75) Inventors: Takaaki Hashimoto, Himeji-shi (JP); Masahide Shima, Himeji-shi (JP); Hironobu Ono, Himeji-shi (JP); Masafumi Sugio, Himeji-shi (JP)

Correspondence Address: WENDEROTH, LIND & PONACK, L.L.P., 2033 K STREET N. W., SUITE 800, WASHINGTON, DC, 20006-1021, US

(73) Assignee: NIPPON SHOKUBAI CO., LTD., Osaka (JP)

(21) Appl. No.: 11/992,416

(22) PCT Filed: Sep. 22, 2006
(86) PCT No.: PCT/JP2006/318871

§ 371 Date: Mar. 21, 2008

(30) Foreign Application Priority Data
Sep. 22, 2005 (JP) 2005-275097

(51) Int. Cl. B32B 15/02; B32B 15/04; H01B 1/22

(52) U.S. Cl. 428/323; 428/402; 252/512; 977/773

(57) ABSTRACT

The object of the present invention is provide a metal nanoparticle which has a nano-sized average diameter while being highly stable as a particle, and a method for producing such metal nanoparticle. Particularly provides a metal nanoparticle having characteristics such as particle diameter and particle size distribution suitable for forming a conductive coating layer, and a method for producing such metal nanoparticle. The metal nanoparticle of the present invention is characterized in that it is obtained by reacting a reducing agent act on a solution containing an organic acid metal salt and an amine.

### TECHNICAL FIELD

The present invention relates to a metal nanoparticle and a method for producing the metal nanoparticle, forms of metal nanoparticle (specifically, metal nanoparticle colloid, paste, powder), a method for storing a metal nanoparticle colloid, and a metal coating film using a metal nanoparticle colloid or a metal nanoparticle paste.

### BACKGROUND ART

### (Metal Nanoparticle and Method for Producing the Same)

Since metal fine particles have various applications, and many kinds of techniques have been proposed. For example, as the method for producing a metal fineparticle, there are methods for preparing metal fineparticles in a gas phase, such as an evaporation method in a gas and sputtering method. However, by such gas-phase methods, it has been difficult to prepare a uniform metal fine particle of several nm.

Further, there is a method for preparing a metal nanoparticle in a liquid phase. For example, in Japanese Patent Application Laid-Open Publication No. 2004-232012, there is disclosed a method for producing dispersion liquid of metal fine particle where an organic metal salt is dissolved in a solvent containing an organic acid having carbon numbers of 10 or less to prepare an organic metal salt solution, which is reduced with hydrazine, and the like. In Japanese Patent Application Laid-Open Publication No. 2004-107728, there is disclosed a compound type metal nanoparticle that after a metal salt and an alcohol-based organic substance are mixed and heat-synthesized, by adding a reducing agent thereto for heat-reduction, the circumference of a nucleus made of each metal particle is bonded/coated with an organic substance made mainly of C, H and/or O. In Japanese Patent Application Laid-Open Publication No. 2004-051997, there is disclosed a method for preparing dispersion liquid of metal fine particle where each metal colloid superfine particle dispersed in a disperser is present as a nucleus, and a metal is precipitated on the surface of the nucleus by a reduction method to form a metal colloid fine particle. Further, in Japanese Patent Application Laid-Open Publication No. 2003-193118, there is disclosed a method for producing a metal fine particle by the processes that a reducing agent is added to an aqueous solution of metal salt to generate a metal fine particle, a protective colloid dissolved in a first organic solvent incompatible with water is added thereto to produce a mixture of two phases, the mixture of two phases is stirred to phase-transfer the metal fine particle into the first organic solvent, and the water and the first organic solvent are removed, and the metal fine particle is redispersed in a second organic solvent.

However, metal nanoparticles are highly reactive, thus unstable as a particle, in particular, metal nanoparticles tend to become coarse, so that it has been difficult to prepare a metal nanoparticle stably in the above methods.

Further, in a method for producing a metal nanoparticle in a liquid phase, polymeric components such as polyvinyl pyrrolidone (PVP) are often used as a stabilizer, and it has been difficult to prepare a high-concentrated solution thereof.

Further, as the method for producing a metal nanoparticle in a liquid phase, it is also well known to produce a metal nanoparticle by reacting an organic acid metal salt and an amine compound. For example, in Japanese Patent Application Laid-Open Publication No. 2002-329419, there are disclosed a method for producing a metal element-containing organic compound paste, including a step of reaction by adding amines to a metal element-containing salt of organic acid, a step of separating layers, and a step of recovering a layer containing a metal fine particle, and electric devices using this paste.

The metal fine particle obtained by a method described in Japanese Patent Application Laid-Open Publication No. 2002-329419 is explained as a particle diameter of 0.1 μm (100 nm) or less, but there is no description on its particle size distribution.

Incidentally, for example, as an ink composition for drawing a conductive pattern, upon using metal fine particles that the average particle diameter exceeds 10 nm, the particle diameter is not uniform and its particle size distribution is large, aggregation tends to occur in storage of ink as a dispersion substance of metal fine particles, as a result, when a circuit pattern is drawn using an inkjet device, there was a possibility of causing a problem such as clogging. Further, in the case where a conductive metal coating film is formed by baking treatment and the like using such metal fine particles, since a space between particles becomes large, there have been caused problems such that formation of uniform membrane becomes difficult and adhesion on a substrate is lowered.

As described above, a metal nanoparticle obtained by a conventional method for preparing a metal nanoparticle in a liquid phase is still insufficient in the points of particle diameter and uniformity of particle (particle size distribution) and the like, and further improvement has been desired.

### (Metal Nanoparticle Colloid and Method for Storing the Same)

In Japanese Patent Application Laid-Open Publication No. 2005-081501, there is a description that a dispersion liquid containing metal nanoparticles is used for forming a metal fine line or a metal membrane, having conductivity. In Japanese Patent Application Laid-Open Publication No. 2004-277627, there is a description that an inkjet ink containing a metal oxide fine particle and polyhydric alcohol and/or polyether compound is used for forming a metal-containing thin membrane. Japanese Patent Application Laid-Open Publication No. 2004-027347 discloses a metal colloid organosol with a narrow particle size distribution that has a concentration of 10 mmol/kg or more and a nano-sized metal colloid particle, and is described that the metal colloid particle is suitable for a material for catalyst and a magnetic recording material according to the description.

However, metal nanoparticles are highly reactive, thus unstable as particles, in particular, metal nanoparticles tend to become coarse, it is difficult to store nanoparticles as it is right after metal nanoparticles are obtained, thus it cannot be considered that a dispersion liquid (metal nanoparticle colloid) containing metal nanoparticles or metal oxide nanoparticles is sufficient in stability for a long time. In particular, when a metal nanoparticle colloid is used in a product containing a lot of other compounds such as ink, there is a case that aggregation of particles may occur.

### (Metal Coating Film Using Metal Nanoparticle)

It is well known that there is a metal paste method as one of methods for forming a metal coating film. For example, in Japanese Patent Application Laid-Open Publication No. 2004-164876, there is disclosed a method for producing a metal coating film where a dispersion substance that a reducible metal oxide having a particle diameter of 200 nm or less is dispersed in an organic dispersion medium is coated on a substrate, then, baked in an inert atmosphere, subsequently baked in a reducing atmosphere.

However, a metal coating film obtained by a method described in Japanese Patent Application Laid-Open Publication No. 2004-164876 is high in specific resistance value, and has not been a satisfied one as a conductive coating film used in an electrode, wiring, circuit and the like.

### DISCLOSURE OR THE INVENTION

### Problem to be Solved by the Invention

The present invention is accomplished in view of the above-described problems, an object of the present invention is to provide a metal fine particle (metal nanoparticle), which has a nano-sized average particle diameter and is highly stable as a particle, and a method for producing such nanoparticle. In particular, it aims to provide a metal nanoparticle having characteristics such as suitable particle diameter and particle size distribution for forming a conductive coating film layer and a method for producing such nanoparticle.

Further, it aims to provide a dispersion liquid of metal nanoparticles (metal nanoparticle colloid) that the metal nanoparticles hardly aggregate and a sedimentation phenomenon hardly appears.

Further, it aims to provide a metal coating film which has a low specific resistance value and is suitable for a conductive coating film, and a method for producing the metal coating film.

### Means to Solve the Problem

A metal nanoparticle of the present invention is characterized in that it is obtained by making a reducing agent act on a solution containing an organic acid metal salt and an amine. It is a preferable embodiment to obtain the metal nanoparticle of the present invention by making a reducing agent act on a solution consisting of an organic acid metal salt and an amine.

Additionally, in the present specification, “a metal nanoparticle” includes, in addition to

a metal nanoparticle, a metal oxide nanoparticle, and a mixture of a metal nanoparticle and a metal oxide nanoparticle. For example, when a metal nanoparticle is a copper nanoparticle, copper can also exist in oxide forms such as Cu₂O and CuO.

It is a preferable embodiment that in the metal nanoparticle of the present invention, formation and growth of a metal nucleus are conducted at 100° C. or less. Additionally, in the present specification, “formation and growth of a metal nucleus” means processes in which a nucleus of metal nanoparticle is formed, and the metal nucleus grows until obtaining a target metal nanoparticle. Further, it is a preferable embodiment that a change of liquid temperature ΔT in reacting the reducing agent with the solution is 20° C. or less. By doing so, the metal nanoparticle of the present invention can be one that an average particle diameter (D) is 10 nm or less, and σ/D (σ: standard deviation in particle size distribution of metal nanoparticle) is 0.2 or less.

A metal nanoparticle colloid of the present invention is characterized in that it is obtained by dispersing the metal nanoparticle in an organic solvent. The present invention includes a metal nanoparticle colloid that the metal nanoparticle is contained in the organic solvent by 1 to 80% by mass. Further, the present invention includes a metal nanoparticle colloid that the metal nanoparticle is dispersed in an organic solvent, and an average particle diameter of the metal nanoparticle (D) is 1 nm to 100 nm, the metal nanoparticle is contained by 8% by mass or more, and σ/D is 0.2 or less.

The present invention includes a method for storing a metal nanoparticle colloid that the metal nanoparticle coated with a protective agent is dispersed in an organic solvent is stored at the melting point of the protective agent or lower. Further, the present invention includes a method for storing a metal nanoparticle colloid that the metal nanoparticle coated with a protective agent is dispersed in an organic solvent is stored at 10° C. or less. Further, the present invention includes a method for storing a metal nanoparticle colloid, wherein in the metal nanoparticle colloid that the metal nanoparticle coated with a protective agent is dispersed in an organic solvent, the coating amount of the protective agent relative to the metal nanoparticle is 30 to 150 parts by mass relative to 100 parts by mass of the metal nanoparticle. Further, the present invention includes a method for storing a metal nanoparticle colloid, wherein in the metal nanoparticle colloid that the metal nanoparticle coated with a protective agent is dispersed in an organic solvent, and the metal nanoparticle is contained in the metal nanoparticle colloid by 10 to 80% by mass

The present invention includes a method for transporting a metal nanoparticle colloid, wherein the metal nanoparticle colloid that the metal nanoparticle coated with a protective agent is dispersed in an organic solvent is transported at the melting point of the protective agent or lower, or at 10° C. or less. In the above-described method for transporting a metal nanoparticle colloid, it is a preferable embodiment that transportation is conducted in a shielding condition.

The present invention includes a metal nanoparticle paste obtained by eliminating the organic solvent and/or the protective agent from the metal nanoparticle colloid. Further, the present invention includes a metal nanoparticle powder obtained by drying the metal nanoparticle paste.

The metal nanoparticle colloid or the metal nanoparticle paste of the present invention can be suitably used as a conductive composition. The present invention includes an electric device having a coating layer formed by using the conductive composition.

The present invention includes a metal coating film obtained in such manner that the metal nanoparticle colloid or the metal nanoparticle paste is coated on a substrate, then, baked at 100 to 600° C. in an oxidizing atmosphere, after that, baked at 100 to 600° C. in a reducing atmosphere. In the metal coating film of the present invention, it is a preferable mode that baking is conducted at 100 to 600° C. in an inert atmosphere or in a reducing atmosphere before the baking in the oxidizing atmosphere.

Further, the present invention includes a metal coating film obtained in such manner that the metal nanoparticle colloid or the metal nanoparticle paste is coated on a substrate, then, baked under an atmospheric pressure more than 1 atmospheric pressure (0.1013 MPa) in a reducing atmosphere. In particular, it is a preferable mode to be baked at 50 to 600° C.

In the metal coating film of the present invention, it is a preferable embodiment that the reducing atmosphere is a hydrogen gas.

The method for producing a metal nanoparticle of the present invention is characterized in that the metal nanoparticle is obtained by adding a reducing agent to a solution containing an organic acid metal salt and an amine. In the method for producing a metal nanoparticle of the present invention, it is a preferable embodiment to obtain a metal nanoparticle by adding a reducing agent to a solution made only of an organic acid metal salt and an amine.

In the method for producing a metal nanoparticle of the present invention, it is a preferable embodiment that formation of a metal nucleus, and growth of the metal nucleus are conducted at 100° C. or less. Further it is a preferable embodiment that a change of liquid temperature ΔT in adding the reducing agent to the solution is 20° C. or less.

The present invention includes a method for producing a metal coating film, wherein the metal nanoparticle colloid obtained by dispersing the metal nanoparticle produced by the method in an organic solvent is coated on a substrate, then baked at 100 to 600° C. in an oxidizing atmosphere, after that, baked at 100 to 600° C. in a reducing atmosphere. In the method for producing a metal coating film of the present invention, it is a preferable embodiment that baking is conducted at 100 to 600° C. in an inert atmosphere or in a reducing atmosphere before the baking in the oxidizing atmosphere.

Further, the present invention includes a method for producing a metal coating film, wherein the metal nanoparticle colloid obtained by dispersing the metal nanoparticle produced by the method in an organic solvent is coated on a substrate, then, baked under a pressure more than 1 atmospheric pressure (0.1013 MPa) in a reducing atmosphere. In particular, it is a preferable embodiment to be baked at 50 to 600° C.

In the method for producing a metal coating film of the present invention, it is a preferable embodiment that the reducing atmosphere is a hydrogen gas.

### EFFECT OF THE INVENTION

According to the present invention, it was able to obtain a metal nanoparticle which has a nano-sized average particle diameter and is highly conductive and stable. In particular, it was able to easily produce a metal nanoparticle with fineness and excellent uniformity which has the average particle diameter of 10 nm or less and also σ/D of 0.2 or less.

Further, according to the present invention, it was able to obtain a metal nanoparticle colloid which can maintain the dispersion state for a long time. Further, it was able to maintain the dispersion state of colloid preventing aggregation of particles in transporting the metal nanoparticle colloid of the present invention. The metal nanoparticle colloid according to the present invention can ensure a sufficient amount of metal fine particles, thus it enables an ink constituted by inclusion of the metal nanoparticle colloid to have a low specific resistance value, and to form fine wiring as well.

Further, according to the present invention, it was able to form a metal coating film which is low in specific resistance value and suitable for an electrode, wiring, circuit and the like.

### BEST MODE FOR CARRYING OUT THE INVENTION

Hereinafter, best mode for carrying out the invention will be described

### (Metal Nanoparticle)

The metal nanoparticle according to the present invention is characterized in that it is obtained by reacting a reducing agent with a solution containing an organic acid metal salt and an amine.

As the organic acid metal salt used in the present invention, it is not particularly limited, and it may be a metal salt of an organic acid.

As an organic acid forming the organic acid metal salt of the present invention, it is not particularly limited, but it is preferably an organic acid capable of easily preparing a homogeneous mixed solution from an organic acid metal salt and an amine, and capable of thermal decomposition at a relatively low temperature. As the organic acid of the present invention, for example, organic acids having an acid functional group such as a carboxylic acid, sulfonic acid, phenol and thiol are listed. Preferably, it is an organic acid having a carboxylic acid. As the carboxylic acid, there are listed formic acid, acetic acid, oxalic acid, tartaric acid, citric acid, phthalic acid, methacrylic acid, propionic acid, butyric acid, isobutyric acid, lactic acid, benzoic acid, hexanoic acid, 2-ethylhexanoic acid, heptanoic acid, octanoic acid, nonanoic acid, decanoic acid, undecanoic acid, dodecanoic acid, tetradecanoic acid, neodecanoic acid, oleic acid, linolic acid, linolenic acid, stearic acid, acrylic acid and the like.

As a metal forming the organic acid metal salt of the present invention, it is not particularly limited, but it is preferably one capable of easily preparing a mixed solution from an organic acid metal salt and an amine, and capable of relatively easily being reduced and obtaining a nano-sized metal fine particle inexpensively and stably. As the metal of the present invention, for example, there are listed Mn, Fe, Co, Ni, Cu, Zn, Ru, Rh, Pd, Ag, Re, Os, Ir, Pt, Au, Mo, In, Ti and Al. These metals may be used alone, or two or more of these may be used in combination. Preferably, it is at least one kind selected from the group consisting of Fe, Ni, Co, Cu, Pd, Ag and Ru.

As a specific example of the organic acid metal salt of the present invention, for example, in the case where Cu is used as the metal, there are listed copper formate, copper acetate, copper oxalate, copper tartarate, copper citrate, copper phthalate, copper methacrylate, copper oleate, copper stearate, copper myristate, copper 2-ethylhexanoate, copper tetradecanoate, copper neodecanoate and the like. These organic acid copper salts may be used alone, or two or more of these may be used in combination. More preferably, it is at least one kind selected from the group consisting of copper formate, copper acetate, copper oxalate, copper oleate, copper stearate, copper myristate, copper 2-ethylhexanoate and copper neodecanoate. Further, as the organic acid metal salt, it is possible to use copper carboxylate and other organic acid metal salt, for example, silver carboxylate and the like, in combination.

As an amine used in the present invention, it is not particularly limited, but it is preferably an amine capable of easily preparing a mixed solution of the organic acid metal salt and an amine, and capable of producing a metal nanoparticle stably, more preferably an amine dissolving the organic acid metal salt. As the amine of the present invention, for example, there are listed monoethanolamine, ethylenediamine, propylamine, butylamine, trimethylamine, pentylamine, hexylamine, heptylamine, nonylamine, decylamine, undecylamine, dodecylamine, tridecylamine, tetradecylamine, pentadecylamine, hexadecylamine, trioctylamine and butylethanolamine, and the like, and preferable are amines having carbon numbers of 6 or more such as hexylamine, octylamine, nonylamine, decylamine, undecylamine, dodecylamine, tridecylamine, tetradecylamine, pentadecylamine, hexadecylamine, trioctylamine and dodecyldimethylamine. These amines may be used alone, or two or more of these may be used in combination, but the amine used is preferably constituted by a single amine in order to easily remove amines physically by distillation, crystallization and the like.

The amount to be used of amine is preferably 0.5 moles or more relative to 1 mole of organic acid metal salt, more preferably 1 mole or more, further preferably 3 moles or more, and preferably 30 moles or less, more preferably 20 moles or less, and further preferably 15 moles or less. When it is less than 0.5 moles, since a homogeneous mixed solution of the organic acid metal salt and the amine cannot be prepared, aggregation tends to occur in reduction. Further, when it is more than 30 moles, such addition is no more effective for preparing a finer particle and needs an excess cost therefore.

As a reducing agent used in the present invention, it is not particularly limited as long as it exhibits a reduction function, it is preferably a reducing agent having a strong reduction power capable of easy reduction near room temperature. For example, as the reducing agent of the present invention, there are listed dimethylamine borane, tert-butylamine borane, hydrazine, hydrogen, sodium boron hydride, potassium boron hydride, lithium aluminum hydride, potassium aluminum hydride, amine, methanol, ethanol, ethylene glycol, formaldehyde, acetaldehyde, formic acid and its salt, oxalic acid and its salt, citric acid and its salt, succinic acid and its salt, ascorbic and its salt, and the like. These reducing agents may be used alone, or two or more of these may be used in combination. Preferably, it is at least one kind selected from the group consisting of hydrogen, sodium boron hydride, dimethylamine borane, formic acid and its salt. Each reducing agent may be used as it is, or may be used after being dissolved in other organic solvent such as water, methanol and ethanol.

The amount to be used of the reducing agent is preferably 0.1 moles or more relative to 1 mole of organic acid metal salt, more preferably 0.3 moles or more, and preferably 10 moles or less, and more preferably 5 moles or less. When the amount to be used of the reducing agent is less than 0.1 moles, sufficient reduction cannot be done, thus, there is a case that no metal nanoparticle is generated. When it is more than 10 moles, since reduction power is too strong, there is a case that particles aggregate and no metal nanoparticle is obtained.

In the present invention, in the solution containing the organic acid metal salt and the amine, there may be included water, alcohols such as methanol, ethanol, propanol, butanol and ethylene glycol, and other solvents such as hexane, heptane, octane, decane, toluene and xylene. Additionally, when the content of these other solvents becomes large, metal fine particles aggregate in reduction and it becomes difficult to obtain a nano-sized metal fine particle.

Therefore, the metal nanoparticle according to the present invention is preferably obtained by reacting the reducing agent with a solution made only of the organic acid metal salt and the amine.

Further, regarding the metal nanoparticle of the present invention, under normal pressure, formation and growth of a metal nucleus are preferably conducted at 100° C. or less, more preferably 80° C. or less, further preferably 55° C. or less, and preferably at 0° C. or more, and more preferably 10° C. or more.

When formation and growth of the metal nucleus are conducted at a reaction temperature exceeding 100° C., aggregation tends to occur in reaction. Further, when conducted at less than 0° C., preparation of a homogeneous mixed solution of the organic acid metal salt and the amine often becomes difficult and there is a case that reduction speed becomes slow due to low temperature.

Further, in the metal nanoparticle of the present invention, a change of liquid temperature ΔT in reacting the reducing agent with a solution containing the organic acid metal salt and the amine (preferably, a solution made of the organic acid metal salt and the amine) is preferably 20° C. or less, more preferably less than 20° C., further preferably 10° C. or less, more further preferably 5° C. or less, and particularly preferably, it is controlled substantially at a constant temperature.

In an origination described in the foregoing Japanese Patent Application Laid-Open Publication No. 2002-329419, the production of a metal element-containing organic compound paste undergoes a two-step reaction containing a step in which amines are added to a metal element-containing salt of organic acid, reaction is conducted at 40 to 80° C. for 4 to 96 hours, and a step in which reaction is further conducted at a temperature higher by 20 to 50° C. than the reaction temperature in the previous step for 10 minutes to 8 hours. In contract, in the present invention, while maintaining a change of liquid temperature ΔT in formation and growth of a metal nucleus, and adding a reducing agent within the above-described temperature range, a reaction is conducted for a necessary amount of time, specifically, for example, preferably 0.1 hours or more, more preferably 0.2 hours or more, and preferably 5 hours or less, more preferably 3 hours or less, thereby it is possible to efficiently produce a metal nanoparticle that the average particle diameter is preferably 10 nm or less, more preferably 8 nm or less, further preferably 7 nm or less, and preferably 2 nm or more, and more preferably 3 nm or more, and also σ/D (σ: standard deviation, D: average particle diameter) is preferably 0.2 or less, more preferably 0.19 or less, further preferably 0.18 or less, and preferably 0.01 or more, and more preferably 0.02 or more.

The method for measuring an average particle diameter (D) of metal nanoparticles can use an ordinary measuring method, for example, it can be done by measuring particle diameters using a transmission electron microscope (TEM), a field emission transmission electron microscope (FE-TEM), a field emission scanning electron microscope (FE-SEM), and the like. Additionally, in the present invention, an average particle diameter (D) and a standard deviation (σ) were obtained by measuring particle diameters of metal nanoparticles using a field emission scanning electron microscope (FE-SEM) and calculating the average and standard deviation.

The metal nanoparticle of the present invention, after the reducing agent reacts with the solution containing the organic acid metal salt and the amine (preferably, the solution made of the organic acid metal salt and the amine), is present in a reaction liquid together with the organic acid and the excess amine, or by-products generated from these and the reducing agent. The metal nanoparticle of the present invention can be used in this reaction liquid as it is, or can be used after taking out the metal nanoparticle by heating from this reaction liquid to remove impurities such as the organic acid and the excess amine. As a preferable method for taking out the metal nanoparticle from this reaction liquid of the present invention, there is mentioned a method where a solution such as water, ethanol and acetone is added to the reaction liquid after reduction, and left still, allowing the metal nanoparticle to generate precipitates together with the excess amine and the like, next, these precipitates are collected by filtration with a membrane filter and the like. Additionally, a method for removing the excess amine and the like from such precipitates will be described below.

### (Method for Producing Metal Nanoparticle)

The method for producing a metal nanoparticle of the present invention is characterized by obtaining a metal nanoparticle by adding a reducing agent to a solution containing an organic acid metal salt and an amine (preferably, a solution formed from an organic acid metal salt and an amine). Further, in the method for producing a metal nanoparticle of the present invention, it is preferable that formation and growth of a metal nucleus are conducted at 100° C. or less, and that a change of liquid temperature ΔT in reacting the reducing agent with the solution is set at 20° C. or less.

In the method for producing a metal nanoparticle of the present invention, preferable modes of an organic acid metal salt, amine and reducing agent used therein, a preferable temperature range in conducting formation and growth of a metal nucleus, and a preferable change of liquid temperature ΔT in adding a reducing agent are as described above.

Additionally, as the organic acid metal salt preferably used in the method for producing a metal nanoparticle of the present invention by setting a change of liquid temperature ΔT in formation and growth of a metal nucleus and adding a reducing agent to be in the above-described temperature range, there is mentioned an organic acid metal salt constituted by at least one kind of metal selected from the group consisting of Pt, Pd, Ru, Ag, Fe, Co, Ni, Cu, Mo, In, Ir, Ti and Al.

Further, the method for producing a metal nanoparticle of the present invention is preferably done in such manner that the organic acid metal salt and the amine are sufficiently stirred, after a homogeneous solution is obtained, a solution or gas containing the reducing agent is slowly added thereto, thereby to conduct reduction treatment.

### (Metal Nanoparticle Colloid)

The metal nanoparticle colloid of the present invention can be easily obtained by dispersing the above-described precipitates of metal nanoparticle and amine in an organic solvent.

As an organic solvent used for preparing the metal nanoparticle colloid, it may be one that can disperse metal nanoparticles, there can be generally used a hydrocarbon, ketone, ester, ether, alcohol, amine and fatty acid and the like. Among these, for example, there can be preferably used normal hexane, cyclohexane, normal pentane, normal heptane, octane, decane, undecane, dodecane, tetradecane, hexadecane, toluene, xylene, methyl isobutyl ketone, benzene, chloroform, carbon tetrachloride, methyl ethyl ketone, acetone, cyclohexanone, methyl isobutyl ketone, acetyl acetone, ethyl acetate, butyl acetate, isobutyl acetate, ethylbenzene, trimethylbenzene, ethylene glycol monomethyl ether, ethylene glycol monoethyl ether, propylene glycol monomethyl ether, terpineol, methanol, ethanol, propyl alcohol, butanol, hexanol, heptanol, octanol, decanol, cyclohexanol, terpineol ethylene glycol, diethylene glycol, 1,2-propanediol, 1,3-propanediol, 1,4-butanediol, 2,3-butanediol, pentanediol, hexanediol, octanediol, 2-dimethylaminoethanol, 2-diethylaminoethanol, 2-dimethylaminoisopropanol, 3-diethylamino-1-propanol, 2-dimethylamino-2-methyl-1-propanol, 2-methylaminoethanol, 4-dimethylamino-1-butanol, formic acid, acetic acid, propionic acid, butyric acid, isobutyric acid, hexanoic acid, 2-ethylhexanoic acid, heptanoic acid, octanoic acid, nonanoic acid, decanoic acid, undecanoic acid, dodecanoic acid, tetradecanoic acid, neodecanoic acid, oleic acid, linolic acid, linolenic acid, methacrylic acid, acrylic acid, ethylenediamine, propylamine, butylamine, trimethylamine, pentylamine, hexylamine, heptylamine, octylamine, nonylamine, decylamine, undecylamine, dodecylamine, tridecylamine, tetradecylamine, pentadecylamine, hexadecylamine, trioctylamine, dodecyldimethylamine, butylethanolamine and the like. These organic solvents may be used alone, or two or more of these may be used in combination. Further, it is preferable to contain at least one component selected from toluene, xylene, decane, tetradecane, 1,3-propanediol, 2-dimethylaminoethanol, octylamine, dodecylamine, 2-ethylhexanoic acid and neodecanoic acid. More preferable are xylene, decane, tetradecane, octylamine and dodecylamine.

The amount to be used of solvent relative to 100 parts by mass of precipitates is preferably 100 parts by mass or more, more preferably 300 parts by mass or more, and preferably 10000 parts by mass or less, and more preferably 5000 parts by mass or less. When the amount to be used of solvent is less than 100 parts by mass, it is difficult to prepare a dispersion substance of metal nanoparticle (metal nanoparticle colloid). Further, even when the amount to be used of solvent is more than 10000 parts by mass, solubility of metal nanoparticle remains unchanged.

As described above, the metal nanoparticle colloid of the present invention may be obtained by dispersing the precipitates of metal nanoparticle and the excess amine and the like in the organic solvent, but, to increase the metal content in the metal nanoparticle colloid, it is preferable to eliminate the excess amine, and the like. The method for eliminating the excess amine, and the like is not particularly limited, for example, methods such as thermal decomposition, extraction and coagulation are listed. As the method for eliminating the excess amine, and the like by coagulation, there is mentioned a method where the metal nanoparticle colloid that precipitates of metal nanoparticle and the excess amine and the like are dispersed in the organic solvent (hereinafter, may be called “a coarse metal nanoparticle colloid” in some cases) is cooled (for example, 5° C. or less) to coagulate the excess amine, and the like, the excess amine and the like is again filtered out with a membrane filter, and the filtrate is a metal nanoparticle colloid. For example, when dodecylamine is used as an amine, a coarse metal nanoparticle colloid is cooled at 20° C. or less to coagulate the excess amine (dodecylamine) and the like, the excess amine (dodecylamine) and the like is filtered out with a membrane filter, and the filtrate is a metal nanoparticle colloid, which is a preferable method because of low cost and easiness. Additionally, it is further preferable that the organic solvent in the filtrate obtained is removed under reduced pressure, then, dispersed again in the above-described organic solvent to obtain a metal nanoparticle colloid of the present invention. By doing so, it is possible to prepare a metal nanoparticle colloid containing less impurities, and metal nanoparticles at a high concentration.

The metal nanoparticle colloid of the present invention preferably has an average particle diameter of 1 nm or more, more preferably 2 nm or more, and preferably 200 nm or less, and more preferably 100 μm or less.

Additionally, as described below, in the case where the metal nanoparticle colloid of the present invention is used as a conductive composition, it is preferable that the above-described metal nanoparticle is contained in the above-described organic solvent by 1 to 80% by mass.

Further, as the conductive composition, preferable is the metal nanoparticle colloid where the above-described metal nanoparticle is dispersed in the above-described organic solvent, an average particle diameter of the metal nanoparticle is 1 nm to 100 nm, the metal nanoparticle is contained by 8% by mass or more, and σ/D is 0.2 or less.

### (Method for Storing Metal Nanoparticle Colloid and Method for Transporting the Same)

The method for storing a metal nanoparticle colloid of the present invention is characterized in that the metal nanoparticle colloid that the metal nanoparticle coated with a protective agent is dispersed in an organic solvent is stored at the melting point of the protective agent or lower. Hereinafter, the storage method of the present invention will be described in detail.

As a metal nanoparticle that the storage method of the present invention is suitably used, there is mentioned a nanoparticle constituted by at least one kind of metal selected from the group consisting of Au, Ag, Cu, Pt, Pd, Ru, Fe, Co, Ni, Mo, In, Ti and Al, and/or by at least one kind of metal oxide selected from the group consisting of copper oxide, silver oxide, nickel oxide and ruthenium oxide. Preferably, it is a nanoparticle constituted by copper or silver metal or copper oxide or silver oxide.

The average particle diameter of metal nanoparticles that the storage method of the present invention is suitably used is preferably 1 nm or more, and preferably 100 nm or less, more preferably 50 nm or less, and further preferably 10 nm or less.

The storage method of the present invention is particularly effective to one with a uniform average particle diameter of metal nanoparticles, for example, one with σ/D of 0.2 or less is preferred.

As the protective agent used in the present invention, it may be any one as long as it ordinarily coats a metal nanoparticle, for example, a compound having a functional group such as a carboxyl group, an amino group and a thiol group, a surfactant and an amphipathic polymer are listed. Among these, there are preferably used 2-dimethylaminoethanol, 2-diethylaminoethanol, 2-dimethylaminoisopropanol, 3-diethylamino-1-propanol, 2-dimethylamino-2-methyl-1-propanol, 2-methylaminoethanol, 4-dimethylamino-1-butanol, formic acid, acetic acid, propionic acid, butyric acid, isobutyric acid, hexanoic acid, heptanoic acid, octanoic acid, nonanoic acid, decanoic acid, undecanoic acid, dodecanoic acid, tetradecanoic acid, oleic acid, linolic acid, linolenic acid, stearic acid, oxalic acid, tartaric acid, phthalic acid, methacrylic acid, citric acid, acrylic acid, benzoic acid, cholic acid, ethylenediamine, propylamine, butylamine, trimethylamine, pentylamine, hexylamine, heptylamine, octylamine, nonylamine, decylamine, undecylamine, dodecylamine, tridecylamine, tetradecylamine, pentadecylamine, hexadecylamine, trioctylamine, dodecyldimethylamine, butylethanolamine, octanethiol, decanethiol, dodecanethiol, L-cystine, sodium sulfosuccinate, sodium dodecylbenzenesulfonate, polyvinyl alcohol, polyvinyl pyrrolidone, polyethylene glycol and the like. These protective agents may be used alone, or two or more of these may be used in combination. Preferably, it is at least one protective agent selected from dodecanoic acid, oleic acid, stearic acid, octylamine, dodecylamine and dodecanethiol.

As a method for coating the metal nanoparticle with the protective agent, it is not particularly limited, there are listed methods in which the metal nanoparticle is prepared by a evaporation method in vacuum gas for evaporating a metal under a low vacuum, a high-frequency plasma method for evaporating a metal by plasma or a laser plasma method for evaporating a metal by laser, thereafter, attached with the protective agent; or the metal nanoparticle is attached with the protective agent when preparing the metal nanoparticle by an in-liquid reduction method for reducing a solution of the organic acid metal salt and the amine in the solution to which a protective agent has been previously added, or by a reverse micelle method or an ultrasonic reduction method.

As the organic solvent used for dispersing the metal nanoparticle coated with the protective agent, it is not particularly limited, the above-described organic solvent used in preparing the metal nanoparticle colloid of the present invention is mentioned.

The storage method of the present invention is conducted in such manner where the metal nanoparticle colloid that the metal nanoparticle coated with the protective agent is dispersed in the organic solvent is stored at the melting point of the protective agent or lower. Specifically, in the case where the melting point of the protective agent used is 10° C. or more, it is preferable to keep the metal nanoparticle colloid at the melting point or lower, more preferably at 10° C. or less. Further, in the case where the melting point of the protective agent is 10° C. or less, it is preferable to keep the metal nanoparticle colloid at 10° C. or less, more preferably at the melting point or lower. By keeping the metal nanoparticle colloid at such temperature, it is possible to store the metal nanoparticle colloid stably for a long time. For example, when dodecylamine whose melting point is higher than 10° C. is used as the protective agent, it is preferable to keep the metal nanoparticle colloid at 23° C. being the melting point of dodecylamine or less, preferably at 10° C. or less. Further, when octylamine whose melting point is less than 10° C. is used as the protective agent, it is preferable to keep the metal nanoparticle colloid at 10° C. or less, preferably 5° C. or less, and more preferably −3° C. or less.

In place of the above storage method or together with the above storage method, the storage method of the present invention may be implemented in such manner that the coated amount of the protective agent relative to the metal nanoparticle is preferably 30 parts by mass or more relative to 100 parts by mass of the metal nanoparticle, more preferably 50 parts by mass or more, and preferably 150 parts by mass or less, and more preferably 130 parts by mass or less.

Further, in place of the above storage method or together with the above storage method, the storage method of the present invention may be implemented in such manner that the metal nanoparticle coated with the protective agent is contained in the metal nanoparticle colloid preferably by 10% by mass or more in terms of metal, more preferably 20% by mass or more, and preferably 80% by mass or less, and more preferably 70% by mass or less.

In the storage method of the present invention, the metal nanoparticle colloid may contain a dye, carbon particle, antistatic agent, hardening accelerator, leveling agent, precipitation-preventing agent, coupling agent, antifoaming agent, corrosion inhibitor of substrate and the like.

The metal content in the metal nanoparticle colloid in the storage method of the present invention is preferably 10% by mass or more, more preferably 15% by mass or more, further preferably 20% by mass or more, and most preferably 25% by mass or more. Further, it is preferably 99% by mass or less, more preferably 90% by mass or less, and further preferably 80% by mass or less. When the metal content exceeds 99% by mass, handling becomes difficult due to lack of fluidity of the metal nanoparticle colloid.

The storage method of the present invention may be implemented using a metal nanoparticle prepared by any mode, but it is preferably implemented using the metal nanoparticle obtained by the present invention. The metal nanoparticle of the present invention has a small average particle diameter, and excellent uniformity. Therefore, the metal nanoparticle colloid that such metal nanoparticle is dispersed in an organic solvent is excellent in a long-time stability (dispersibility) and metal nanoparticles hardly aggregate (sedimentation phenomenon hardly occurs). Besides, the storage method of the present invention can maintain the metal nanoparticle colloid in a dispersion state for a further long period of time by using the metal nanoparticle of the present invention.

In the case where the storage method of the present invention is applied to the nanoparticle obtained by the present invention, the amine can be the protective agent.

The present invention includes a method for transporting the metal nanoparticle colloid, wherein the metal nanoparticle colloid that the metal nanoparticle coated with the protective agent is dispersed in the organic solvent is transported at the melting point of the protective agent or lower, or at 10° C. or less. By such constitution, even when a sort of impact is given to the metal nanoparticle colloid, transportation of metal nanoparticle colloid can be stably conducted because aggregation of metal nanoparticles can be effectively prevented.

Additionally, the transportation method of the present invention is implemented preferably in a light-shielding condition. The light-shielding method is not particularly limited, for example, it can be realized by putting the metal nanoparticle colloid in a container capable of shielding a light of visible light region (380 nm to 800 nm) by 20% or more, preferably 50% or more. Further, light shielding may be done by slits and the like. Additionally, the light shielding is also effective to the method for storing the metal nanoparticle colloid of the present invention as well.

Regarding the mode of metal nanoparticle, the protective agent, the organic solvent used in the transportation method of the present invention and the coating method of metal nanoparticles with the protective agent, these may be the same as those used in the method for storing the metal nanoparticle colloid of the present invention, but it is preferable to use the metal nanoparticle obtained by the present invention. The metal nanoparticle colloid of the present invention is excellent in a longtime stability (dispersibility) and metal nanoparticles hardly aggregate, by applying the transportation method of the present invention to the metal nanoparticle of the present invention, the metal nanoparticles more hardly aggregate in the metal nanoparticle colloid upon its transportation.

### (Metal Nanoparticle Paste)

The metal nanoparticle paste of the present invention can be obtained by removing the organic solvent and excess amine from the metal nanoparticle colloid of the present invention. Additionally, the organic solvent and excess amine need not be completely removed, according to applications, it may be removed into an optimum concentration. Further, according to applications, solvents may be suitably added, such as normal hexane, cyclohexane, normal pentane, normal heptane, toluene, methyl isobutyl ketone, benzene, chloroform, carbon tetrachloride, methyl ethyl ketone, ethyl acetate, butyl acetate, isobutyl acetate, ethylbenzene, terpineol, hexadecane, methanol, ethanol, propyl alcohol and butanol.

The content of the metal nanoparticle in the metal nanoparticle paste of the present invention is preferably 3% by mass or more, more preferably 5% by mass or more, and preferably 80% by mass or less, and more preferably 70% by mass or less. When the content of the metal nanoparticle is less than 3% by mass, preparation of metal nanoparticle paste is possible by a method other than the present invention. On the other hand, when the content of the metal nanoparticle is more than 80% by mass, there is a case that viscosity of metal nanoparticle paste becomes high and handling becomes difficult.

### (Metal Nanoparticle Powder)

The metal nanoparticle powder of the present invention can be obtained by further drying the metal nanoparticle paste of the present invention or drying the metal nanoparticle colloid of the present invention.

### (Conductive Composition and Electric Device Formed by Using the Conductive Composition)

The metal nanoparticle contained in the metal nanoparticle paste of the present invention has a small average diameter and excellent uniformity Further, the metal nanoparticle colloid of the present invention is excellent in a long-time stability (dispersibility) and metal nanoparticles hardly aggregate. Further, the metal nanoparticle colloid stored (transported) by the storage (transportation) method of the present invention is excellent in a long-time stability (dispersibility) and metal nanoparticles hardly aggregate as well. Therefore, the metal nanoparticle colloid of the present invention (including metal nanoparticle colloid after storage/transportation) can ensure a sufficient amount of metal nanoparticles.

Therefore, the metal nanoparticle paste of the present invention and the metal nanoparticle colloid of the present invention are suitable as a conductive composition.

Further, as a conductive composition, suitable is the metal nanoparticle colloid that metal nanoparticles with an average particle diameter of 10 nm or less, and also σ/D of 0.2 or less are contained preferably by 1% by mass or more, and more preferably 30% by mass or more, and preferably 80% by mass or less, and more preferably 60% by mass or less.

Further, as a conductive composition, suitable is the metal nanoparticle colloid that an average particle diameter of metal nanoparticles is 1 nm or more, and preferably 100 nm or less, more preferably 50 nm or less and further preferably 10 nm or less; metal nanoparticles are contained preferably by 8% by mass or more, more preferably by 15% by mass or more, further preferably by 20% by mass or more, and most preferably by 25% by mass or more, and preferably 99% by mass or less, more preferably 90% by mass or less, further preferably 80% by mass or less, and most preferably 70% by mass or less, and also σ/D is preferably 0.2 or less, more preferably 0.19 or less, and further preferably 0.18 or less.

When such a conductive composition is used as an ink composition for drawing a conductive pattern to produce a conductive pattern in an electric device, a uniform coating film can be formed, which enables production of a metal coating film with an excellent conductivity.

When an average particle diameter of metal nanoparticles is more than 100 nm, wiring width becomes wide in the case where the conductive composition of the present invention is used as an ink composition for drawing a conductive pattern for wiring. Further, when content of metal nanoparticle is more than 99% by mass or more, the metal nanoparticle colloid lacks flowability and its handling becomes difficult.

The above-described two metal nanoparticle colloids suitably used in the conductive composition of the present invention may be prepared by either mode, but it is preferable to use the method for producing a metal nanoparticle of the present invention because the metal nanoparticle colloids of the modes can be easily produced.

In the case where the amine used for obtaining the metal nanoparticle is contained in the metal nanoparticle colloid, it is preferable that such amine is contained by 30 parts by mass or more, and 150 parts by mass or less relative to 100 parts by mass of the metal nanoparticle. It is possible to stabilize the metal nanoparticle colloid thereby for a further long period of time.

In the case where the conductive composition of the present invention is used as an ink composition for drawing a conductive pattern, an organic binder may further be added to this metal nanoparticle colloid. As the organic binder, there are listed a phenoxy resin, polyurethane, polyvinyl butyral, polyamide, polyimide, polyamideimide, polycarbonate, polyphenylene ether, polyvinyl ether, polysulfone, polyvinyl alcohol, polyvinyl formal, polyvinyl acetate, (meth)acrylate resin, polyester resin, cellulosic resin, ionomer resin, epoxy resin, phenol resin, polyimide resin, polyurethane resin, melamine resin, urea resin and the like. These binders may be used alone, or two or more of these may be used in combination. Further, according to applications of ink, there may be suitably added a dye, carbon particle, antistatic agent, hardening accelerator, leveling agent, precipitation-preventing agent, coupling agent, antifoaming agent, corrosion inhibitor of substrate and the like.

The conductive composition of the present invention is used such as an ink composition for drawing a conductive pattern, by which it can be suitably used in an electric device such as metal wiring and terminal electrode having a coating layer formed by using the conductive composition. As the electric device, specifically, there are listed a multilayer tip capacitor, multilayer tip inductor, chip resistor, build-up substrate, flexible printed substrate, glass substrate, ceramic substrate and the like.

The coating layer constituting the electric device of the present invention is formed in such manner that the conductive composition of the present invention is coated on a predetermined substrate, then dried or subjected to heat treatment such as baking, which attaches metal or metal oxide contained in the conductive composition onto the surface of the substrate, thereby to be metallized without modification or by reduction treatment if necessary.

As a method for coating the conductive composition onto the substrate, it is not particularly limited, and coating can be conducted by a method generally used in coating of this kind of colloid. Specifically, for example, there can be adopted a screen printing method, dip coating method, spray method, inkjet method, spin coating method and the like, and coating is preferably done by an inkjet method.

As the substrate used in the present invention, it is not particularly limited as long as it is a substrate which is generally used for constituting an electrode, wiring, circuit and the like, and has heat resistance not being burn away or deteriorated by baking. Specifically, for example, there are listed metal substrates such as iron, copper and aluminum; heat resistant resin substrates such as a polyimide film; a glass substrate and the like.

Further, the heat treatment conducted in the present invention is implemented preferably in any one of atmospheres of vacuum, inert gas, oxidizing gas and reducing gas. Further, the heat treatment temperature in this case is preferably ambient temperature or higher, more preferably 50° C. or more, further preferably 100° C. or more, more further preferably 150° C. or more, and preferably 500° C. or less, more preferably 450° C. or less, and further preferably 400° C. or less. When the heat treatment temperature is lower than ambient temperature, it takes too much time to remove solvents such as an organic solvent contained in the conductive composition. Additionally, to remove carbonaceous substances contained in the conductive composition, the heat treatment temperature is preferably 100° C. or more. Further, when the heat treatment temperature exceeds 500° C., metals contained in the conductive composition grow greatly, for example, when wiring is formed, fine line is difficult to obtain.

The coating layer constituting the electric device of the present invention is composed of metal components, and it shows conductivity of metal itself. Particularly, copper is suitable from the viewpoints of low specific resistance value and electromigration resistance.

### (Metal Coating Film Using Metal Nanoparticles and Method for Producing the Same)

A mode of metal coating film according to the present invention is characterized in that a metal nanoparticle colloid or a metal nanoparticle paste is coated on a substrate, then, baked at 100 to 600° C. in an oxidizing atmosphere, after that, baked at 100 to 600° C. in a reducing atmosphere to obtain the coating film.

The metal coating film obtained with such constitution has a low specific resistance value, and can be a conductive coating film capable of being used suitably as an electrode, wiring, circuit and the like.

As a preferable specific example of the metal nanoparticle used in the present invention, there is mentioned a metal nanoparticle that the average particle diameter is preferably 1 nm or more, more preferably 2 nm or more, and preferably 200 nm or less, more preferably 100 nm or less, that is composed of at least one kind of metal selected from Pt, Au, Pd, Ru, Ag, Fe, Co, Ni, Cu, Mo, Ir, In, Ti and Al. Among these, a metal nanoparticle having an average particle diameter of 10 nm or less, and also excellent uniformity is preferably used. Further, a metal nanoparticle composed of Ag and/or Cu is preferably used.

The metal coating film of the present invention is formed by using a metal nanoparticle colloid or a metal nanoparticle paste that the above-described metal nanoparticles are dispersed in an organic solvent. As the organic solvent used herein, it is not particularly limited as long as it is an organic solvent generally used for preparing a metal nanoparticle colloid or a metal nanoparticle paste, and the solvent used for preparing the metal nanoparticle colloid or the metal nanoparticle paste of the present invention is mentioned.

The content of metal nanoparticle in the metal nanoparticle colloid or the metal nanoparticle paste can be suitably determined, 3% by mass or more is preferable, 5% by mass or more is more preferable, and 80% by mass or less is preferable, 70% by mass or less is more preferable.

In the metal nanoparticle colloid or the metal nanoparticle paste, impurities generated in a production process and unreacted raw materials may be contained as long as they do not give a significantly adverse effect to the performance of a metal coating film formed by baking, but from consideration of the performance of a metal coating film, it is desirable that such impurities and the like are eliminated as much as possible before using.

The metal nanoparticle colloid or the metal nanoparticle paste used in the present invention may be prepared by either mode as long as a nano-sized metal fine particle (particle of metal (zero valence), particle of metal oxide, and a mixture thereof) whose average particle diameter is in the foregoing range is dispersed in the organic solvent (preferably homogeneous dispersion).

Herein, the metal nanoparticle contained in the metal nanoparticle paste of the present invention has a small average diameter and excellent uniformity. Further, the metal nanoparticle colloid of the present invention or the metal nanoparticle colloid stored (transported) by the storage (transportation) method of the present invention is excellent in dispersibility and metal nanoparticles hardly aggregate, ensuring a sufficient amount of metal nanoparticle. Therefore, the metal nanoparticle colloid of the present invention (including metal nanoparticle colloid after storage/transportation) and the metal nanoparticle paste of the present invention can be used suitably for producing the metal coating film of the present invention.

According to the present invention, a metal nanoparticle colloid or a metal nanoparticle paste is coated on a substrate, then, baked at a temperature of 100 to 600° C. in an oxidizing atmosphere, after that, baked at a temperature of 100 to 600° C. in a reducing atmosphere to obtain the metal coating film. Hereinafter, each process thereof will be described in detail.

As a substrate used in the present invention and a coating method of the metal nanoparticle colloid or the metal nanoparticle paste onto this substrate, they are not particularly limited, and they can adopt the substrate which has been used for forming the coating layer constituting the electric device of the present invention and the coating method onto the substrate.

The baking method in an oxidizing atmosphere is not particularly limited, for example, it is such a method that a substrate coated is set in an incinerator, while an oxidizing atmosphere, for example, oxygen or a mixed gas of oxygen gas and inert gas such as nitrogen gas or helium gas, typically, air is filling or circulating in the incinerator, baking may be conducted preferably at 100° C. or more, and preferably 600° C. or less, more preferably 450° C. or less, and further preferably 350° C. or less. By baking in this oxidizing atmosphere, organic substances contained in the metal nanoparticle colloid or metal nanoparticle paste coated on the substrate can be eliminated by combustion, thus, it is possible to improve conductivity of a metal coating film finally obtained. When baking in this oxidizing atmosphere is not conducted, a small amount of organic substance or carbonaceous substance remains as impurities in coat, so that there is a case that conductivity of a metal coating film is lowered.

The baking method in a reducing atmosphere is also not particularly limited, for example, it is such a method that following the above-described baking method in an oxidizing atmosphere, while a reducing atmosphere, for example, hydrogen, or a mixed gas of hydrogen gas and inert gas such as nitrogen gas or helium gas (hydrogen concentration: 0.1 to 10%) is filing or circulating in the incinerator, baking may be conducted at the same temperature as the baking temperature in the above-described oxidizing atmosphere. By baking in this reducing atmosphere, coat that a part of or all of metal became a state of metal oxide by baking in the oxidizing atmosphere is reduced into metal, which can provide the coat with conductivity.

When the baking temperature in the above-described oxidizing atmosphere or reducing atmosphere is less than 100° C., or more than 600° C., there is a case that the respective effects described above cannot be obtained.

Baking in the above-described oxidizing atmosphere and baking in the reducing atmosphere followed thereby are not necessarily conducted continuously, between the above-described baking treatments, another treatment and the like may be conducted. For example, when baking in a reducing atmosphere is conducted using hydrogen gas, after baking in an oxidizing atmosphere, before circulating hydrogen gas, it is preferable to conduct an atmosphere-replacing treatment by nitrogen (N₂ purge) for several minutes for safety reasons.

In the metal nanoparticle colloid or the metal nanoparticle paste right after it is coated on a substrate, there is a case that a large amount of organic substances are contained, thus, when the substrate coated is immediately baked in an oxidizing atmosphere, this large amounts of organic substances burn, and generate heat rapidly, as a result, there are cases that crack of coat and peeling of coat from the substrate take place. Hence, when baking is conducted in an oxidizing atmosphere right after coating the metal nanoparticle colloid or the metal nanoparticle paste onto the substrate, controls such as slow raising temperature become necessary, as a result, there arises a problem that an operation time is lengthened. Thus, in the present invention, it is preferable that before baking in the above-described oxidizing atmosphere, the substrate coated is preferably baked beforehand in an inert atmosphere or a reducing atmosphere at the same temperature as the baking temperature range in the above-described oxidizing atmosphere and reducing atmosphere. Particularly, it is preferable to conduct baking in a reducing atmosphere.

Therefore, another mode of the metal coating film of the present invention is constituted in such manner that a metal nanoparticle colloid or a metal nanoparticle paste is coated on a substrate, then baked at 100 to 600° C. in an inert atmosphere or a reducing atmosphere, after that, baked at 100 to 600° C. in an oxidizing atmosphere, further, baked at 100 to 600° C. in a reducing atmosphere.

Additionally, the baking in an inert atmosphere or a reducing atmosphere is that a substrate coated is set in an incinerator in the same manner as the baking in the above-described oxidizing atmosphere, while an inert gas, for example, nitrogen gas or a reducing gas, for example, hydrogen gas or a mixed gas of hydrogen and nitrogen gas (hydrogen concentration: 0.1 to 10%) is filling or circulating in the incinerator, baking may be conducted. By the baking in such an inert atmosphere or reducing atmosphere, it is possible to eliminate organic substances to an extent of not generating a rapid exothermic heat by combustion on baking in the oxidizing atmosphere, thus, the process can be shortened in terms of time, and an advantageous effect is obtained in an industrial implementation.

Further, another mode of the metal coating film according to the present invention is characterized in that a metal nanoparticle colloid or a metal nanoparticle paste is coated on a substrate, then, baked under an atmospheric pressure higher than 1 atmospheric pressure (0.1013 MPa) in a reducing atmosphere to obtain the coating film.

By such constitution, since reduction of the metal coating film easily proceeds even at a low temperature that sufficient reduction was conventionally difficult, the resulting metal coating film becomes high in conductivity. Therefore, by the present invention, it is able to form a conductive coating film that is low in specific resistance value and suitable for using in an electrode, wiring, circuit and the like.

The mode of the metal nanoparticle colloid or metal nanoparticle paste used in the present invention (metal for forming the metal nanoparticle, an average particle diameter, an organic solvent, and a content of metal nanoparticle, and the like) may be the same as the metal nanoparticle colloid or metal nanoparticle paste used in one mode of the above-described metal coating film.

According to the present invention, a metal nanoparticle colloid or metal nanoparticle paste is coated on a substrate, then, this substrate coated is baked under a pressure higher than 1 atmospheric pressure (0.1013 MPa) in a reducing atmosphere for reduction treatment, thereby to form a metal coating film. Hereinafter, the respective processes thereof will described in detail.

As the substrate used in the present invention and the coating method of the metal nanoparticle colloid or the metal nanoparticle paste onto this substrate, they may be same as the substrate used in one mode of the above-described metal coating film and the coating method.

The above-described reducing atmosphere according to the present invention may be a state of being filled with a reducing gas such as carbon monoxide and hydrogen by 100%, or a state that such reducing gas is diluted with an inert gas such as nitrogen and helium, but, a state of being filled with hydrogen is preferable. The pressure in conducting the above described treatment is not particularly limited as long as it is higher than 1 atmospheric pressure (0.1013 MPa), the upper limit is suitably determined in considerations of pressure resistance of equipment or substrates, preferably, it is 0.2 MPa or more, and 1 MPa or less.

The baking in the present invention is conducted preferably at 50° C. or more, and preferably at 600° C. or less, more preferably at 300° C. or less, and further preferably at 200° C. or less.

### EXAMPLES

Hereinafter, the present invention will be described more specifically with reference to Examples, the present invention is not to be restricted by the following Examples, it can be suitably modified within a scope adapting to the spirit described before and later, and implemented, these are all included in the technical scope of the present invention. Additionally, unless otherwise noted, in Examples and Comparative examples) “part” represents part by mass, and “%” represents “% by mass.” Additionally, specific resistance value was measured using a low resistivity meter, Loresta GP (manufactured by Mitsubishi Chemicals Corporation)

### Example 1

Copper acetate monohydrate (manufactured by Wako Pure Chemical Industries, Ltd.) of 15.7 g as an organic acid metal salt and dodecylamine (manufactured by Wako Pure Chemical Industries, Ltd.) of 148.1 g as an amine were mixed while stirring at 60° C. for 20 minutes. Next, the resulting mixture was cooled to 40° C., then reduction treatment was conducted by slowly adding 20 g of 20% sodium boron hydride aqueous solution as reducing agent thereto. Acetone of 200 g was added while stirring the solution which was subjected to the reduction treatment, allowed to stand for a while, then, precipitates composed of copper and organic substances were separated by filtration.

Toluene was added to the precipitates to dissolve again, and then the resulting solution was cooled to 10° C. Excess dodecylamine was coagulated and filtered out, thereby to give a liquid that fine particles of copper were dispersed in toluene. Next, by distilling toluene away from the copper fine particle-toluene dispersion liquid, a copper nanoparticle paste was prepared. The copper nanoparticle paste was measured by FE-SEM to observe a copper nanoparticle of about 5 nm.

### Example 2

A 1 L-glass beaker was charged with copper acetate monohydrate (manufactured by Wako Pure Chemical Industries, Ltd.) of 15.7 g as an organic acid metal salt and octylamine (manufactured by Wako Pure Chemical Industries, Ltd.) of 101.6 g as an amine, and mixed while stirring at 40° C. for 10 minutes. Next, the glass beaker was put into a constant-temperature water bath at 30° C., a solution of dimethylamine borane dissolved (reducing agent) was slowly added thereto over 0.5 hours for the liquid temperature to be around 40° C., subjected to a reduction treatment, formation of a metal nucleus and the growth were completed.

Acetone of 200 g was added to the solution which was subjected to the reduction treatment, allowed to stand for a while, then, precipitates composed of copper and organic substances were separated and recovered by filtration with a membrane filter having a pore diameter of 0.1 μm. Toluene was added to the recovered substance to dissolve again, the resulting solution was cooled to 10° C., then filtered again with a membrane filter. Subsequently, after toluene was removed under reduced pressure, a tetradecan solvent was added thereto, and a copper nanoparticle colloid containing 40% of copper nanoparticle was obtained.

The above-described copper nanoparticle colloid was observed by FE-SEM to find that the average particle diameter of copper nanoparticles was 5 nm and the value of σ/D was 0.14.

### Comparative Example 1

A 1 L-glass beaker was charged with copper acetate monohydrate (manufactured by Wako Pure Chemical Industries, Ltd.) of 15.7 g as an organic acid metal salt and octylamine (manufactured by Wako Pure Chemical Industries, Ltd.) of 101.6 g as an amine, and mixed while stirring at 40° C. for 10 minutes. Next, the mixture was raised to 120° C., then, a solution of dimethylamine borane dissolved (reducing agent) was added and subjected to reduction treatment. The temperature in reduction was 120° C. and almost stable.

The solution after reduction was cooled to 40° C., then, it was tried to prepare a copper nanoparticle colloid containing 40% of copper nanoparticle in the same way as in Example 2. In Example 2, filtration with a membrane filter having a pore diameter of 0.1 μm was easy, but in the present preparation method, filtration was very difficult, so that it took 10-fold time to conduct filtration with a membrane filter having a pore diameter of 1 μm.

The resulting copper nanoparticle colloid was observed by FE-SEM to confirm that the average particle diameter of copper nanoparticles was 20 nm and the value of σ/D was 0.40.

### Example 3

A 1 L-beaker charged with octylamine (manufactured by Wako Pure Chemical Industries, Ltd.) of 148.1 g as an amine was put in a constant-temperature bath at 40° C. Next, copper acetate monohydrate (manufactured by Wako Pure Chemical Industries, Ltd.) of 15.7 g as an organic acid metal salt was added and sufficiently mixed while stirring for 20 minutes to prepare a homogeneous mixed solution. Subsequently, 20 g of a 20% sodium boron hydride aqueous solution as a reducing agent was slowly added thereto, and a reduction treatment was conducted.

Acetone of 200 g was added to the solution which was subjected to the reduction treatment, allowed to stand for a while, then precipitates composed of copper and organic substances were separated and recovered by filtration. Toluene was added to the recovered substance to dissolve again, the resulting solution was cooled to 10° C. or less then, filtered again, thereby to prepare a toluene dispersion liquid that impurities were reduced.

Next, toluene was distilled away by an evaporator, and a copper nanoparticle paste containing 20% of copper nanoparticle was prepared. This paste was a paste that 9% of octylamine and 71% of toluene were contained other than the copper nanoparticle.

This copper nanoparticle paste was observed by FE-SEM to confirm that it was a copper nanoparticle paste having a particle diameter distribution with an average particle diameter of 4 nm and the value of σ/D of 0.14.

Next, printing was conducted on a glass plate by an inkjet printing method using the above-described copper nanoparticle paste. After printing, it was subjected to baking treatment of copper nanoparticles each other by heat treatment at 300° C. for 60 minutes to form a conductive pattern constituted by sintered layers of copper nanoparticles. The average thickness of membrane at that time was 1 μm, and the membrane was measured for specific resistance value to find that it was 5.0 μΩ·cm. Further, aggregation was not able to be confirmed when it was stored in a dark cold place for 2 months.

### Example 4

A 1 L-beaker charged with dodecylamine (melting point: 23° C. to 27° C., manufactured by Wako Pure Chemical Industries, Ltd.) of 160.1 g as an amine was put in a constant-temperature bath at 40° C. Next, copper acetate monohydrate (manufactured by Wako Pure Chemical Industries, Ltd.) of 15.7 g as an organic acid metal salt was added and sufficiently mixed while stirring for 20 minutes to prepare a homogeneous mixed solution. Subsequently, 4.5 g of a dimethylamine borane solution as a reducing agent was slowly added thereto, and reduction treatment was conducted.

Methanol of 200 g was added to the solution which was subjected to the reduction treatment, allowed to stand for a while, then, precipitates composed of copper and organic substances were separated and recovered by filtration. Toluene and decane were added to the recovered substance to dissolve again, the resulting solution was cooled to 10° C., then filtered again, thereby to prepare a toluene dispersion liquid that impurities were reduced.

Next, toluene was distilled off by an evaporator, and a copper nanoparticle paste containing 20% of copper oxide nanoparticle was prepared. This paste was a copper nanoparticle paste containing 15% of dodecylamine and 65% of decane in addition to copper nanoparticles.

This copper nanoparticle paste was observed by FE-SEM to confirm that it was a copper nanoparticle paste having a particle diameter distribution with an average particle diameter of 4 μm and the value of σ/D of 0.15.

This copper nanoparticle paste was stored at 12° C. for 3 months, once again, this copper nanoparticle paste was observed by FE-SEM to confirm that it had the same particle diameter distribution as that in its preparation.

Next, the copper nanoparticle paste stored for 3 months was transported at 5° C. in light-shielding condition. Subsequently, printing was conducted on a glass plate by an inkjet printing method using the copper nanoparticle paste after transportation. After printing, it was subjected to baking treatment of copper nanoparticles each other by heat treatment at 250° C. for 60 minutes to form a conductive pattern constituted by sintered layers of copper nanoparticles. The average thickness of membrane at that time was 1 μm, and the membrane was measured for specific resistance valued to find that it was 6.0 μΩ·cm.

### Comparative Example 2

The copper nanoparticle paste produced in Example 4 was stored in a constant-temperature room at 35° C. higher than the melting point of dodecylamine. After several days, when the copper nanoparticle paste was observed, precipitations took place at the lower part of a container, and it was not able to be stored stably.

### Example 5

A 1 L-beaker charged with octylamine (melting point: −5° C. to −1° C., manufactured by Wako Pure Chemical Industries, Ltd.) of 123.1 g as an amine was put in a constant-temperature bath at 40° C. Next, copper acetate monohydrate (manufactured by Wako Pure Chemical Industries, Ltd.) of 15.7 g as an organic acid metal salt was added and sufficiently mixed while stirring for 10 minutes to prepare a homogeneous mixed solution. Subsequently, 5 g of dimethylamine borane as a reducing agent was slowly added thereto, and reduction treatment was conducted.

Methanol of 200 g was added to the solution which was subjected to the reduction treatment, allowed to stand for a while, then, precipitates composed of copper and organic substances were separated and recovered by filtration. Toluene and decane were added to the recovered substance to dissolve again, the resulting solution was cooled to 10° C. or less, then filtered again, thereby to prepare a toluene dispersion liquid that impurities were reduced.

Next, toluene was distilled away by an evaporator, and a copper nanoparticle paste containing 20% of copper oxide nanoparticle was prepared. This copper nanoparticle paste was a paste containing 18% of octylamine and 62% of decane were contained in addition to the copper fine particle.

This copper nanoparticle paste was observed by FE-SEM to confirm that it was a copper nanoparticle paste having a particle diameter distribution with an average particle diameter of 4.2 nm and the value of σ/D of 0.13.

This copper nanoparticle paste was stored in a refrigerator at 3° C. for 3 months, once again, this copper nanoparticle paste was observed by FE SEM to confirm that it had the same particle diameter distribution as that in its preparation.

### Comparative Example 3

The copper nanoparticle paste prepared in Example 5 was stored in a constant-temperature room at 20° C. After several days, when the copper nanoparticle paste was observed, precipitations took place at the lower part of a container, and it was not able to be stored stably.

### Example 6

### Preparation of Copper Nanoparticle Colloid

Copper acetate monohydrate (manufactured by Wako Pure Chemical Industries, Ltd.) of 15.7 g as an organic acid metal salt and dodecylamine (manufactured by Wako Pure Chemical Industries, Ltd.) of 148.1 g as an amine were mixed while stirring at 60° C. for 20 minutes. Next, the resulting mixture was cooled to 40° C., reduction treatment was conducted by slowly adding 20 g of 20% sodium boron hydride aqueous solution as reducing agent thereto. Acetone of 200 g was added while stirring the solution which was subjected to the reduction treatment, allowed to stand for a while, then, precipitates composed of copper and organic substances were separated by filtration.

Toluene was added to the precipitates to dissolve again, then, the resulting solution was cooled to 10° C. Excess dodecylamine was coagulated and filtered out, thereby to give a liquid that fine particles of copper were dispersed in toluene. Next, by distilling toluene away from the copper nanoparticle-toluene dispersion liquid, a copper nanoparticle paste that the content of copper nanoparticle was 55% was prepared. The average particle diameter of copper nanoparticles in this copper nanoparticle paste was measured by FE-SEM to find that it was 5 nm.

By adding a suitable amount of tetradecane (manufactured by Wako Pure Chemical Industries, Ltd.) to the above-described copper nanoparticle paste and mixing while stirring, a copper nanoparticle colloid containing 30% of copper nanoparticle was obtained.

### Production of Metal Coating Film

The copper nanoparticle paste obtained in the above-described preparation example was coated on a glass substrate in an area of 1 cm×3 cm.

The above-described glass substrate was put in an incinerator, and it was raised to 300° C. over 15 hours while circulating iir in the incinerator. It was held at 300° C. for 0.5 hours after the temperature reached 300° C., and baked in an oxidizing atmosphere. Thereafter, in a condition maintaining the temperature at 300° C., the circulating gas was changed by 5% hydrogen (residue was 95% nitrogen) and maintained for 1 hour, and baking was conducted in a reducing atmosphere, thereby to obtain a copper coating film with a film thickness of 0.5 μm. The specific resistance value of the copper coating film obtained was 8×10⁻⁶ Ω·cm.

### Comparative Example 4

A copper coating film with a film thickness of 0.5 μm was obtained in the same manner as in Example 6 except that nitrogen was circulated in the incinerator in place of circulating air in the incinerator in Example 6. The specific resistance value of the copper coating film obtained was 3×10⁻⁴ Ω·cm.

### Example 7

The copper nanoparticle colloid prepared in Example 6 was coated on a glass substrate in an area of 1 cm×3 cm.

The above-described glass substrate was put in an incinerator, and it was raised to 300° C. over 1 hour while circulating nitrogen in the incinerator. It was held at 300° C. for 0.5 hours after the temperature reached 300° C., and baked in an inert atmosphere. Subsequently, in a condition maintaining the temperature at 300° C., the circulating gas was changed by air and maintained for 0.5 hours, and baking was conducted in an oxidizing atmosphere. Thereafter, in a condition maintaining the temperature at 300° C., the circulating gas was changed by 5% hydrogen (residue was 95% nitrogen) and maintained for 0.5 hours, and baking was conducted in a reducing atmosphere, thereby to obtain a copper coating film with a film thickness of 0.5 μm. The specific resistance value of the copper coating film obtained was 9×10⁻⁶ Ω·cm.

### Example 8

The copper nanoparticle colloid prepared in Example 6 was coated on a glass substrate in an area of 1 cm×3 cm.

The above-described glass substrate was put in an incinerator, and it was raised to 300° C. over 1 hour while circulating 5% hydrogen (residue was 95% nitrogen). It was held at 300° C. for 0.5 hours after the temperature reached 300° C., and baked in an inert atmosphere. Subsequently, in a condition maintaining the temperature at 300° C., the circulating gas was changed by air and maintained for 0.5 hours, and baking was conducted in an oxidizing atmosphere. Thereafter, in a condition maintaining the temperature at 300° C., the circulating gas was changed by 5% hydrogen residue was 95% nitrogen) and maintained for 0.5 hours, and baking was conducted in a reducing atmosphere, thereby to obtain a copper coating film with a film thickness of 0.5 μm. The specific resistance value of the copper coating film obtained was 6×10⁻⁶ Ω·cm.

### Comparative Example 5

A copper coating film with a film thickness of 0.5 μm was obtained in the same manner as in Example 8 except that nitrogen was circulated in the incinerator in place of circulating air in the incinerator in Example 8. The specific resistance value of the copper coating film obtained was 2×10⁻⁴ Ω·cm.

### Example 9

### Preparation of Copper Nanoparticle Colloid

Copper acetate monohydrate (manufactured by Wako Pure Chemical Industries, Ltd.) of 15.7 g as an organic acid metal salt and octylamine (manufactured by Wako Pure Chemical Industries, Ltd.) of 103.3 g as an amine were mixed while stirring at 40° C. for 20 minutes, then reduction treatment was conducted by slowly adding 20 g of a 20% sodium boron hydride aqueous solution as reducing agent thereto. Acetone of 200 g was added while stirring the solution which was subjected to the reduction treatment, allowed to stand for a while, then, precipitates composed of copper and organic substances were separated by filtration.

Toluene was added to the precipitates to dissolve again, then, the resulting solution was cooled to 10° C. or less. Excess solid materials were removed by filtration, thereby to give a liquid that copper nanoparticles were dispersed in toluene. Next, by distilling toluene away from this copper nanoparticle-toluene dispersion liquid, a copper nanoparticle paste that the amount of copper nanoparticle was 60% was prepared. The average particle diameter of copper nanoparticles in the copper nanoparticle paste was measured by a field emission transmission electron microscope (FE-SEM) to find that it was 5 nm.

By adding a suitable amount of decane (manufactured by Wako Pure Chemical Industries, Ltd.) to the above-described copper nanoparticle paste and mixing while stirring, a copper nanoparticle colloid containing 30% of copper nanoparticle was obtained.

### Production of Metal Coating Film

The copper nanoparticle colloid obtained in the above-described preparation example was coated on a glass substrate in an area of 1 cm×3 cm.

The above-described glass substrate was put in an autoclave, inside of the autoclave was filled with carbon monoxide and pressure-sealed, then, it was raised to 160° C. from room temperature over 1 hour. It was held at 150° C. for 0.5 hours after the temperature reached 150° C., and baked under a pressure of 0.5 MPa, thereby to obtain a copper coating film of a film thickness of 0.5 μm. The specific resistance value of the copper coating film obtained was 8×10⁻⁶ Ω·cm.

### Comparative Example 6

A copper coating film with a film thickness of 0.5 μm was obtained in the same manner as in Example 9 except that oxygen was used in place of carbon monoxide in Example 9. The copper coating film obtained did not show conductivity.

### Example 10

The copper nanoparticle colloid obtained in Example 9 was coated on a glass substrate in an area of 1 cm×3 cm.

The above-described glass substrate was put in an autoclave, inside of the autoclave was filled with hydrogen and pressure-sealed, then, it was raised to 120° C. from room temperature over 1 hour. It was held at 120° C. for 1 hour after the temperature reached 120° C., and baked under a pressure of 0.5 MPa, thereby to obtain a copper coating film with a film thickness of 0.5 μm. The specific resistance value of the copper coating film obtained was 7×10⁻⁶ Ω·cm.

### Comparative Example 7

The copper nanoparticle colloid obtained in Example 9 was coated on a glass substrate in an area of 1 cm×3 cm.

The above-described glass substrate was put in an autoclave, while passing hydrogen of 1 atmospheric pressure (0.1013 MPa) inside the autoclave, and it was raised to 120° C. from room temperature over 1 hour. It was held at 120° C. for 1 hour after the temperature reached 120° C., and baked under 1 atmospheric pressure (0.1013 MPa), thereby to obtain a copper coating film with a film thickness of 0.5 μm. The copper coating film obtained did not show conductivity.

### INDUSTRIAL APPLICABILITY

The metal nanoparticle of the present invention can be used as a catalyst material and a conductive composition, or formation of a metal coating film, and the like, in addition to as a metal fine particle.

1-32. (canceled)

33. A metal nanoparticle obtained by making a reducing agent act on a solution containing an organic acid metal salt and an amine.

34. The metal nanoparticle according to claim 33, wherein the solution consists essentially of the organic acid metal salt and the amine.

35. The metal nanoparticle according to claim 33, wherein formation and growth of a metal nucleus are conducted at 100° C. or lower.

36. The metal nanoparticle according to claim 33, wherein a change of liquid temperature ΔT in reacting the reducing agent with the solution is 20° C. or lower.

37. The metal nanoparticle according to claim 33, wherein an average particle diameter (D) is 10 nm or less, and σ/D (σ: standard deviation in particle size distribution of metal nanoparticle) is 0.2 or less.

38. A metal nanoparticle colloid obtained by dispersing the metal nanoparticle according to claim 33 in an organic solvent.

39. A method for storing a metal nanoparticle colloid, wherein the metal nanoparticle colloid obtained by dispersing the metal nanoparticle according to claim 33 coated with a protective agent in an organic solvent is stored at a melting point of the protective agent or lower.

40. The method for storing the metal nanoparticle colloid according to claim 39, wherein a coating amount of the protective agent relative to the metal nanoparticle is 30 to 150 parts by mass relative to 100 parts by mass of the metal nanoparticle.

41. The method for storing the metal nanoparticle colloid according to claim 39, wherein the metal nanoparticle is contained by 10 to 80% by mass.

42. A method for transporting a metal nanoparticle colloid, wherein the metal nanoparticle colloid obtained by dispersing the metal nanoparticle according to claim 33 coated with a protective agent in an organic solvent is transported at a melting point of the protective agent or lower, or at 10° C. or lower.

43. The method for transporting the metal nanoparticle colloid according to claim 42, wherein transportation is conducted in a shielding condition.

44. A metal nanoparticle paste which is obtained by removing an organic solvent and/or a protective agent from:
a metal nanoparticle colloid which is obtained by dispersing a metal nanoparticle in the organic solvent wherein the metal nanoparticle is obtained by making a reducing agent act on a solution containing an organic acid metal salt and an amine;
a metal nanoparticle colloid which is obtained by dispersing a metal nanoparticle coated with the protective agent in the organic solvent and is stored by a method for storing the metal nanoparticle colloid at a melting point of the protective agent or lower wherein the metal nanoparticle is obtained by making a reducing agent act on a solution containing an organic acid metal salt and an amine; or
a metal nanoparticle colloid which is obtained by dispersing a metal nanoparticle coated with the protective agent in the organic solvent and is transported by a method for transporting the metal nanoparticle colloid at a melting point of the protective agent or lower, or at 10° C. or lower wherein the metal nanoparticle is obtained by making a reducing agent act on a solution containing an organic acid metal salt and an amine.

45. A metal nanoparticle powder obtained by drying the metal nanoparticle paste according to claim 44.

46. A conductive composition using:
a metal nanoparticle colloid which is obtained by dispersing a metal nanoparticle in an organic solvent wherein the metal nanoparticle is obtained by making a reducing agent act on a solution containing an organic acid metal salt and an amine;
a metal nanoparticle colloid which is obtained by dispersing a metal nanoparticle coated with a protective agent in an organic solvent and is stored by a method for storing the metal nanoparticle colloid at a melting point of the protective agent or lower wherein the metal nanoparticle is obtained by making a reducing agent act on a solution containing an organic acid metal salt and an amine;
a metal nanoparticle colloid which is obtained by dispersing a metal nanoparticle coated with a protective agent in an organic solvent and is transported by a method for transporting the metal nanoparticle colloid at a melting point of the protective agent or lower, or at 10° C. or lower wherein the metal nanoparticle is obtained by making a reducing agent act on a solution containing an organic acid metal salt and an amine; or
the metal nanoparticle paste according to claim 44.

47. An electric device comprising a coating layer formed by using the conductive composition according to claim 46.

48. A metal coating film obtained by coating on a substrate,
a metal nanoparticle colloid which is obtained by dispersing a metal nanoparticle in an organic solvent wherein the metal nanoparticle is obtained by making a reducing agent act on a solution containing an organic acid metal salt and an amine;
a metal nanoparticle colloid which is obtained by dispersing a metal nanoparticle coated with a protective agent in an organic solvent and is stored by a method for storing the metal nanoparticle colloid at a melting point of the protective agent or lower wherein the metal nanoparticle is obtained by making a reducing agent act on a solution containing an organic acid metal salt and an amine;
a metal nanoparticle colloid which is obtained by dispersing a metal nanoparticle coated with a protective agent in an organic solvent and is transported by a method for transporting the metal nanoparticle colloid at a melting point of the protective agent or lower, or at 10° C. or lower wherein the metal nanoparticle is obtained by making a reducing agent act on a solution containing an organic acid metal salt and an amine; or
the metal nanoparticle paste according to claim 44;
followed by baking at 100° C. to 600° C. in an oxidizing atmosphere, and subsequent baking at 100° C. to 600° C. in a reducing atmosphere.

49. The metal coating film according to claim 48, wherein baking is conducted at 100° C. to 600° C. in an inert atmosphere or in a reducing atmosphere before the baking in the oxidizing atmosphere.

50. A metal coating film obtained by coating on a substrate,
a metal nanoparticle colloid which is obtained by dispersing a metal nanoparticle in an organic solvent wherein the metal nanoparticle is obtained by making a reducing agent act on a solution containing an organic acid metal salt and an amine;
a metal nanoparticle colloid which is obtained by dispersing a metal nanoparticle coated with a protective agent in an organic solvent and is stored by a method for storing the metal nanoparticle colloid at a melting point of the protective agent or lower wherein the metal nanoparticle is obtained by making a reducing agent act on a solution containing an organic acid metal salt and an amine;
a metal nanoparticle colloid which is obtained by dispersing a metal nanoparticle coated with a protective agent in an organic solvent and is transported by a method for transporting the metal nanoparticle colloid at a melting point of the protective agent or lower, or at 10° C. or lower wherein the metal nanoparticle is obtained by making a reducing agent act on a solution containing an organic acid metal salt and an amine; or
the metal nanoparticle paste according to claim 44;
followed by baking under an atmospheric pressure more than 1 atmospheric pressure in a reducing atmosphere.

51. The metal coating film of claim 50, wherein baking is conducted at 50° C. to 600° C.

52. The metal coating film according to claim 48, wherein the reducing atmosphere is a hydrogen gas.

53. A method for producing a metal nanoparticle to obtain the metal nanoparticle by adding a reducing agent to a solution containing an organic acid metal salt and an amine.

54. The metal coating film according to claim 50, wherein the reducing atmosphere is a hydrogen gas.
